(19) United States
(12) Patent Application Publication
(10) Pub. No.: US 2026/0296230 A1
(43) Pub. Date: Oct. 1, 2026

(54) CHARGING INLET

(71) Applicant: YAZAKI CORPORATION, Tokyo (JP)

(72) Inventors: Noriyoshi Yamanishi, Kakegawa-shi (JP); Shoya Ueda, Kakegawa-shi (JP)

(21) Appl. No.: 19/342,484

(22) Filed: Sep. 27, 2025

(30) Foreign Application Priority Data
Sep. 30, 2024 (JP) 2024-170495

(51) Int. Cl. B60L 53/16; H01R 13/447; H01R 13/52

(52) U.S. Cl. CPC B60L 53/16; H01R 13/447; H01R 13/5202

(57) ABSTRACT

A charging inlet includes: a housing from which a charging plug is detachable, the housing holding connection terminals therein; a plurality of wiring components inserted into the housing from an outside of the housing through a wiring guide formed on a side of outer surfaces of outer wall portions of the housing; a plurality of waterproof plugs inserted into a plurality of routing passages formed inside the wiring guide together with the corresponding wiring components to close the routing passages; and a cap member that is attached to an external opening portion of the wiring guide, the external opening portion being opened to the outside of the housing, and that has a plurality of abutting portions capable of abutting on the waterproof plugs inside the routing passages from a side of the external opening portion.

### TECHNICAL FIELD

Embodiments of the present invention relate to a charging inlet.

Priority is claimed on Japanese Patent Application No. 2024-170495 filed in Japan on Sep. 30, 2024, the content of which is incorporated herein by reference.

### BACKGROUND ART

Conventionally, a connector installed in a vehicle has been proposed in order to supply (charge) an electric power from an outside of the vehicle to a battery mounted on the vehicle such as an electric vehicle or a plug-in hybrid vehicle (see, for example, Patent Document 1). This type of connector is also commonly referred to as a charging inlet.

### PRIOR ART DOCUMENT

### Patent Document

[Patent Document 1] Japanese Unexamined Patent Application, First Publication No. 2019-186022

### SUMMARY OF THE INVENTION

### Problems to be Solved by the Invention

In the charging inlet, it is expected to facilitate assembly while securing waterproofness.

One embodiment provides a charging inlet having improved assemblability while securing waterproofness.

### Means for Solving the Problem

A charging inlet of one embodiment includes: a housing from which a charging plug is detachable, the housing holding connection terminals therein; a plurality of wiring components inserted into the housing from an outside of the housing through a wiring guide formed on a side of outer surfaces of outer wall portions of the housing; a plurality of waterproof plugs inserted into a plurality of routing passages formed inside the wiring guide together with the corresponding wiring components to close the routing passages; and a cap member that is attached to an external opening portion of the wiring guide, the external opening portion being opened to the outside of the housing, and that has a plurality of abutting portions capable of abutting on the waterproof plugs inside the routing passages from a side of the external opening portion.

### Effects of Invention

According to the one embodiment, a charging inlet having improved assemblability while securing waterproof properties can be provided.

### BRIEF DESCRIPTION OF THE DRAWINGS

FIG. 1 A perspective view of a charging inlet according to one embodiment of the present invention.

FIG. 2 A perspective view of the charging inlet when viewed from a different direction.

FIG. 3 A cross-sectional view along an axial direction of a central portion in a left-right direction of the charging inlet.

FIG. 4 A cross-sectional view along the axial direction of left and right side portions of the charging inlet.

FIG. 5 A perspective view of a state in which a cap member is removed from the wiring guide.

### EMBODIMENTS FOR CARRYING OUT THE INVENTION

Specific embodiments of the present invention will be described below with reference to the drawings. In the following description, constitutions having the same or similar functions are denoted by the same reference signs. Redundant descriptions of these constitutions may be omitted. Note that constitutions described below do not limit the scope of the embodiments.

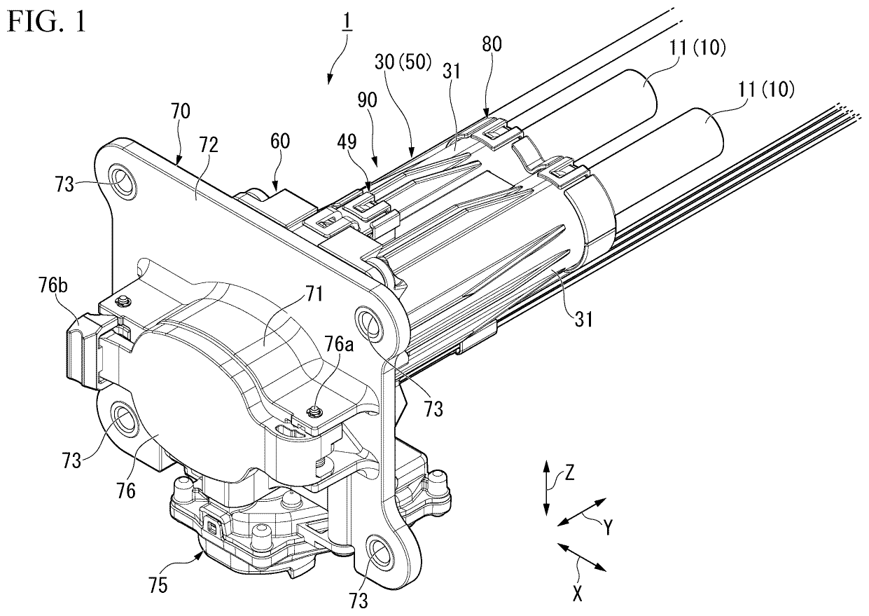

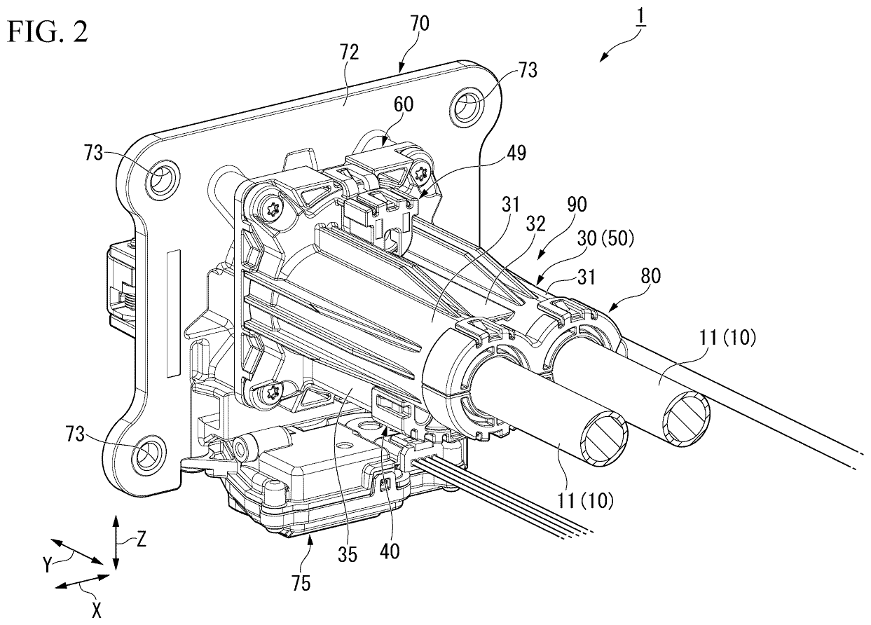

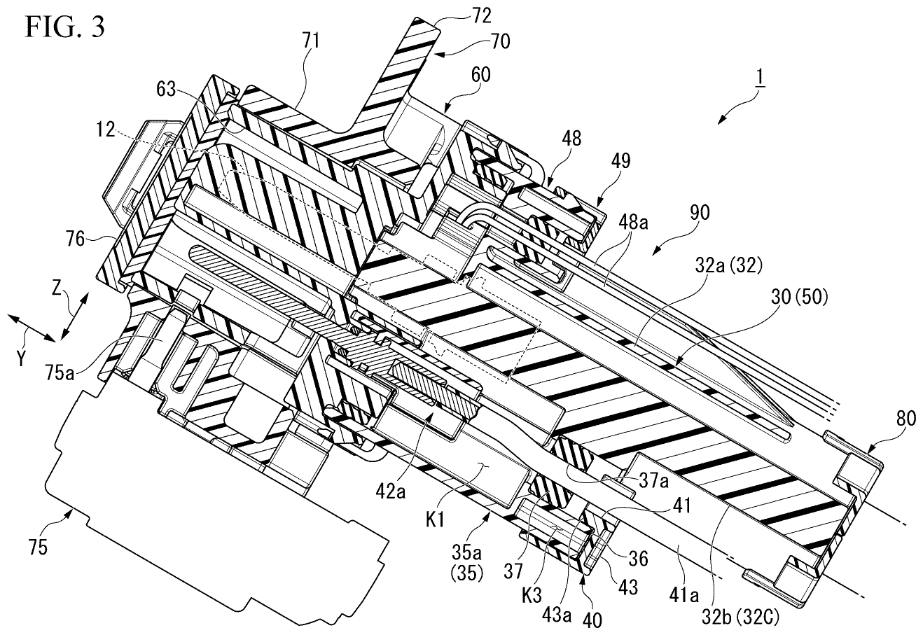

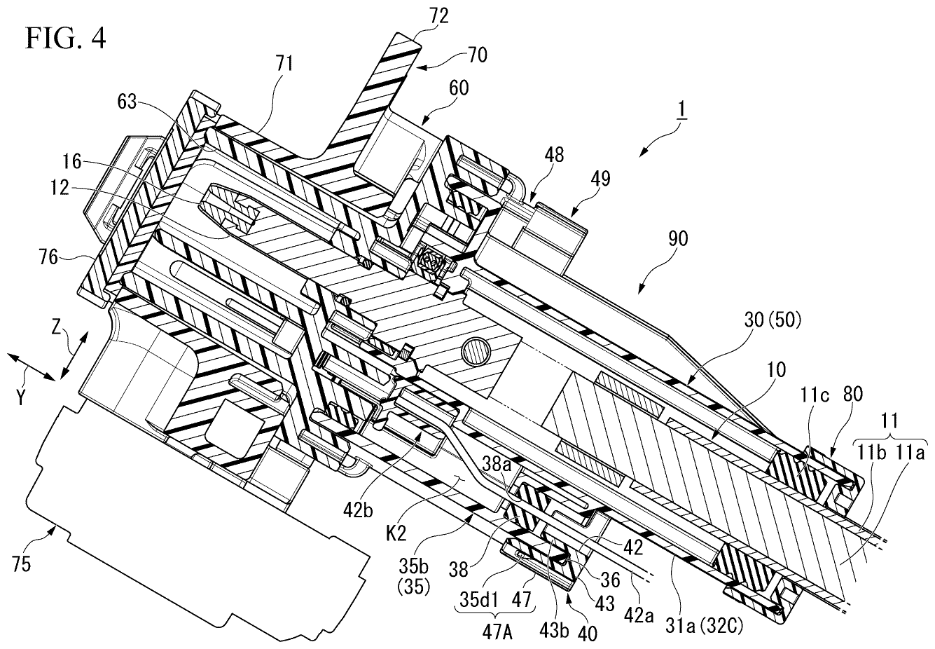

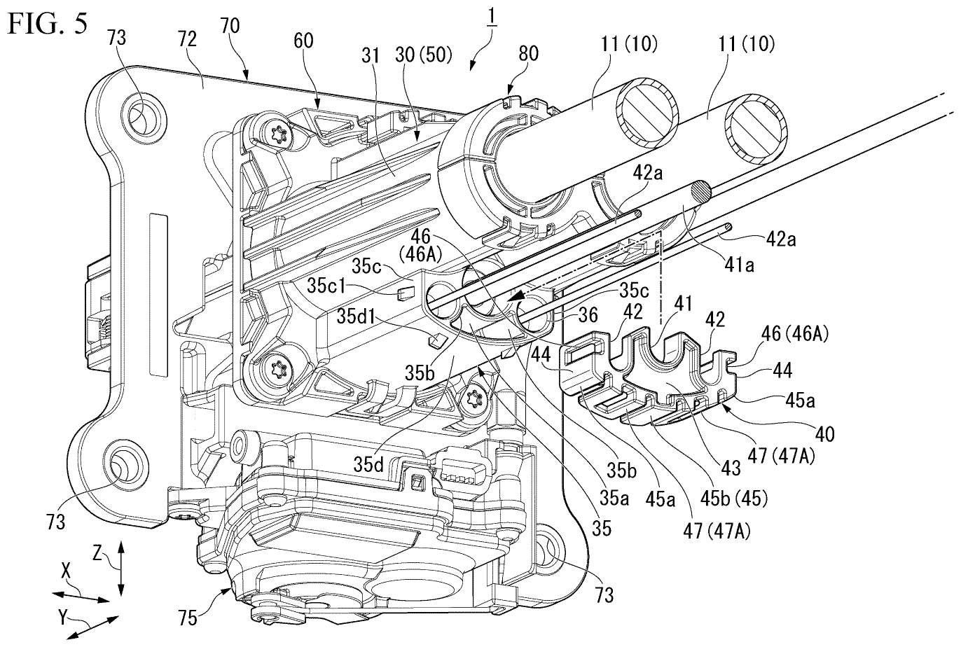

FIGS. 1 and 2 are perspective views of a charging inlet 1 according to one embodiment of the present invention. FIG. 3 is a cross-sectional view along an axial direction of a central portion in a left-right direction of the charging inlet 1. FIG. 4 is a cross-sectional view along an axial direction of side portions in the left-right direction of the charging inlet 1. FIG. 5 is a perspective view of a state in which a cap member 40 is removed from a lower wiring guide 35. Note that in the present specification, a description will be given on the assumption that an arrow X indicates the left-right direction, an arrow Y indicates a front-rear direction, and an arrow Z indicates an up-down direction.

The charging inlet 1 illustrated in FIGS. 1 and 2 is a connector installed in a vehicle equipped with a battery of an electric vehicle (EV), a plug-in hybrid electric vehicle (PHEV) or the like, and connected to an electric wire extending from the battery mounted on the vehicle. A mating connector such as a charging plug (not illustrated) is detachably fitted into a fitting recessed portion 63 (see FIG. 1 and the like) of the charging inlet 1. The mating connector is connected to an electric wire extending from a power feeding device outside the vehicle. By connecting this mating connector to the charging inlet 1, the electric power is supplied to the battery from the power feeding device outside the vehicle, and the battery is charged.

In the embodiment, a description will be given with a fitting direction (an insertion/removal direction) of the charging inlet 1 and the mating connector (not illustrated) as the front-rear direction. In the front-rear direction, a mating connector side is referred to as a front side, and a charging inlet 1 side is referred to as a rear side. That is, the mating connector is fitted in and connected to the charging inlet 1 by movement from the front side to the rear side, and is removed by movement in the opposite direction. The fitting direction may be inclined forward and upward with respect to a horizontal direction. The left and right in the left-right direction are left and right when facing forward.

As illustrated in FIGS. 1 and 2, the charging inlet 1 includes a pair of terminal-equipped electric wires 10 and a housing 90 in which terminals 12 of the pair of terminal-equipped electric wires 10 are accommodated and the pair of terminal-equipped electric wires 10 are held.

Referring also to FIG. 4, the pair of terminal-equipped electric wires 10 connects one-end portions of the pair of electric wires 11 to the pair of terminals 12, respectively. The other-end portions of the pair of electric wires 11 are connected to the battery (not illustrated). Each of the electric wires 11 includes a conductor core wire 11a and a sheath 11b made of an insulating resin that covers the conductor core wire 11a. The electric wires 11 are held inside the housing 90 via rubber stoppers 11c.

The pair of terminals 12 has a same constitution. Each of the terminals 12 extends linearly along the front-rear direction. The terminals 12 are arranged side by side in the left-right direction at intervals. Each of the terminals 12 is inserted into and held in each of a pair of terminal holding portions 31 described later.

For example, each of the terminals 12 is provided with a cylindrical female terminal portion 16 (see FIG. 4) protruding forward from a front end surface thereof. Among the pair of terminals 12, the female terminal portion 16 of one terminal 12 functions as an anode-side terminal, and the female terminal portion 16 of the other terminal 12 functions as a cathode-side terminal. When the charging inlet 1 and the mating connector are fitted to each other, a male terminal portion on an anode side and a male terminal portion on a cathode side (both not illustrated) of the mating connector are connected to the female terminal portion 16 of the one terminal 12 and the female terminal portion 16 of the other terminal 12, respectively.

Rear end portions of the pair of terminals 12 are connected to the one-end portions of the electric wires 11. The conductor core wire 11a exposed at the one-end portion of the electric wire 11 is connected to the rear end portion of each of the terminals 12 directly or via a prescribed conductor component. With this constitution, the terminals 12 and the one-end portions of the electric wires 11 are electrically connected.

### Housing 90

As illustrated in FIGS. 1 and 2, the housing 90 includes a base holder 50, a rear holder 80, an inner housing body 60, and an outer housing body 70. Each of the base holder 50, the rear holder 80, the inner housing body 60, and the outer housing body 70 is a skeletal component of the housing 90 and forms an outer surface of the housing 90.

The base holder 50 functions to hold the pair of terminal-equipped electric wires 10 in a state of insulating the terminal-equipped electric wires 10 from each other with a space in a width direction. The base holder 50 has a resin holder 30 that is a resin molded article.

The resin holder 30 absorbs and radiates heat generated in the pair of terminals 12, and also functions to insulate and protect the pair of terminals 12. The resin holder 30 integrally includes the pair of terminal holding portions (holder bodies) 31 arranged in the width direction (left-right direction) and a coupling portion 32 coupling the pair of terminal holding portions 31 in the width direction. Each of the terminal holding portions 31 has a substantially cylindrical shape extending in the front-rear direction. The terminal 12 is inserted into each of the pair of terminal holding portions 31 from the rear side.

The coupling portion 32 couples the pair of terminal holding portions 31. An upper wiring guide 48 protruding upward is provided on an upper outer surface (upper surface) 32a of the coupling portion 32, and the lower wiring guide 35 protruding downward is provided on a lower outer surface (lower surface) 32b of the coupling portion 32. The upper and lower surfaces 32a, 32b of the coupling portion 32 in the embodiment are planes substantially parallel to the front-rear direction Y and the left-right direction X.

The upper wiring guide 48 has a function of guiding routing of an electric wire of an electric wire component (for example, a thermistor 77 for terminal temperature detection) different from the electric wires 10 for charging. A cap member 49 is attached to the upper wiring guide 48.

The lower wiring guide 35 has a function of guiding routing of electric wires of electric wire components (for example, a ground wiring 41a, various signal wirings 42a, and the like) different from the electric wires 10 for charging. The cap member 40 is attached to the lower wiring guide 35.

The rear holder 80 is attached to a rear end portion of the base holder 50. The rear holder 80 is a resin molded article, is assembled with the base holder 50 from the rear side, and functions to hold the pair of terminal-equipped electric wires 10 in a state with a space in the width direction.

In front of the base holder 50, the inner housing body 60 having a size that surrounds an outside of the pair of terminal holding portions 31 when viewed from the front-rear direction is provided. The inner housing body 60 has a disk shape with a thickness direction oriented in the front-rear direction, and a front end portion of the base holder 50 is coupled to a rear surface portion of the inner housing body 60. The inner housing body 60 is, for example, a resin molded article integrally formed of a same material as that of the base holder 50. Fastening portions for fastening and fixing the inner housing body 60 to the outer housing body 70 by bolts along the front-rear direction are provided on both left and right sides of an upper portion and both left and right sides of a lower portion of the inner housing body 60.

The outer housing body 70 is assembled with the inner housing body 60 from the front side and functions to fix the entire housing 90 to an attachment target portion (not illustrated) provided in the vehicle. The outer housing body 70 is a resin molded article, and has a tubular portion 71 having a cylindrical shape and extending in the front-rear direction. The tubular portion 71 functions to form the fitting recessed portion 63 of the charging inlet 1.

In a rear wall portion (bottom wall portion) of the fitting recessed portion 63, a pair of cylindrical female terminal accommodating portions (not illustrated) is provided so as to protrude forward corresponding to the female terminal portions 16 of the pair of terminals 12. Each of the female terminal accommodating portions is located inside the fitting recessed portion 63, and accommodates each of the female terminal portions 16 therein.

The outer housing body 70 has a flange portion 72 expanding radially outward of the tubular portion 71. The flange portion 72 has a rectangular shape when viewed from the front-rear direction. A bolt insertion hole 73 penetrating in the front-rear direction is formed at each corner portion of the flange portion 72. A bolt (not illustrated) for fixing the charging inlet 1 to the attachment target portion of the vehicle is inserted into the bolt insertion hole 73.

The charging inlet 1 includes an actuator 75 for preventing detachment of the mating connector in a connected state. The actuator 75 is assembled below the charging inlet 1. The actuator 75 includes a lock pin 75a that can be inserted into a prescribed portion of the mating connector in the connected state in a direction (for example, an up-down direction) orthogonal to the fitting direction. The actuator 75 is actuated by a drive signal from a control device (not illustrated), and causes the lock pin 75a to protrude into or retract from the mating connector. With this constitution, it is possible to prevent the mating connector from being accidentally detached or intentionally detached during battery charging, improve safety, and reliably execute a charging cycle every time. The actuator 75 is an independent unit, and is fixed to the housing 90 with bolts and nuts or the like.

A lid 76 for opening and closing a front opening portion of the tubular portion 71 is attached to a front surface side of the outer housing body 70. The lid 76 is rotatable about a hinge shaft 76a disposed on one side of left and right sides (left side in the figure) of the tubular portion 71 and extending in the up-down direction. On the other side of the left and right sides (right side in the figure) of the tubular portion 71, a lock member 76b that holds the lid 76 in a closed state is disposed.

### Lower Wiring Guide 35

Referring to FIGS. 3 to 5, the ground wiring 41a and the pair of left and right signal wirings 42a are disposed on a side of the lower surface 32b of the coupling portion 32 of the housing 90. Each of the wirings 41a, 42a extends in the front-rear direction along the lower surface 32b of the coupling portion 32.

The lower wiring guide 35 is provided below a front portion of the coupling portion 32, the lower wiring guide 35 covering peripheries of attachment portions 41b, 42b of the wirings 41a, 42a to the housing 90 and guiding routing paths of the wirings 41a, 42a.

The lower wiring guide 35 has a cylindrical central guide body 35a and left and right guide bodies 35b. A space having a circular cross section inside the central guide body 35a serves as a routing passage K1 for routing a range of a prescribed length from the attachment portion 41b in the ground wiring 41a. A space having a circular cross section inside each of the left and right guide bodies 35b serves as a routing passage K2 for routing a range of a prescribed length from the attachment portion 42b in each of the signal wirings 42a.

A front end portion of the lower wiring guide 35 abuts on and is joined to a rear portion of the inner housing body 60. A front portion of each of the routing passages K1, K2 terminates before (behind) the inner housing body 60. A rear end portion of each of the routing passages K1, K2 is opened rearward at a rear end portion of the lower wiring guide 35. Hereinafter, the rear end portion of the lower wiring guide 35 is referred to as a rear opening portion 36.

A columnar rubber stopper (waterproof plug) 37 is inserted into a front-rear intermediate portion (not limited to a central portion) of the routing passage K1 together with the ground wiring 41a. The rubber stopper 37 brings an outer peripheral surface into close contact with an inner peripheral surface of the guide body 35a, and prevents water from entering an inner side (a front side) of the routing passage K1. An insertion hole 37a through which the ground wiring 41a is inserted is formed in the rubber stopper 37. By setting an inner peripheral surface of the insertion hole 37a to be in close contact with an outer peripheral surface of the ground wiring 41a, entry of water through the insertion hole 37a is prevented.

A columnar rubber stopper (waterproof plug) 38 is inserted into a front-rear intermediate portion (not limited to a central portion) of each of the routing passages K2 together with each of the signal wirings 42a. The rubber stopper 38 brings an outer peripheral surface into close contact with an inner peripheral surface of each of the guide bodies 35b, and prevents water from entering an inner side (a front side) of the routing passage K2. An insertion hole 38a through which the signal wiring 42a is inserted is formed in the rubber stopper 38. By setting an inner peripheral surface of the insertion hole 38a to be in close contact with an outer peripheral surface of the signal wiring 42a, entry of water through the insertion hole 38a is prevented.

Referring to the cross sections, the lower wiring guide 35 includes the guide body 35a and the left and right guide members 35b each having a cylindrical cross section, a pair of side wall portions 35c forming side surfaces of the guide body 35a on left and right outer sides of the left and right guide members 35b, and a bridged wall portion 35d extending between upper end portions of the pair of side wall portions 35c.

The lower wiring guide 35 has a substantially constant cross section and extends in the front-rear direction. The lower wiring guide 35 is formed not only on the lower surface 32b of the coupling portion 32 but also on left and right inner sides of outer surfaces 31a of lower portions of the left and right terminal holding portions 31. Hereinafter, a portion including the lower surface 32b of the coupling portion 32 and the left and right inner sides of the outer surfaces 31a of the lower portions of the left and right terminal holding portions 31 is referred to as an outer surface 32C.

In a cross-sectional view orthogonal to the front-rear direction in the lower wiring guide 35, a portion surrounded by a lower portion of the central guide body 35a, the left and right inner sides of the lower portions of the left and right guide bodies 35b, and the bridged wall portion 35d is a lightening space K3.

The bridged wall portion 35d is curved in an arc shape so as to follow an outer shape of the inner housing body 60 when viewed from the front-rear direction.

Locking protrusions 35c1, 35d1 for locking the cap member 40 protrude from left and right outer sides of the pair of side wall portions 35c and both left and right sides of the bridged wall portion 35d.

The cap member 40 for partially closing the opening and preventing detachment of the rubber stoppers 37, 38 inside the routing passages K1, K2 is attached to the rear opening portion 36 of the lower wiring guide 35. The cap member 40 includes a rear wall portion 43 that has a shape similar to a rear surface view shape of the rear opening portion 36, and has an inverted U-shaped central cut-out 41 and left and right cut-outs 42 opened downward when viewed from the front-rear direction, a pair of left and right side wall portions 44 extending forward from outer end portions of the rear wall portion 43, and a curved wall portion 45 extending forward from a lower end portion of the rear wall portion 43.

Each of the side wall portions 44 includes a cap-side locking piece 46 constituting a locking structure 46A together with the locking protrusion 35c1 of each of the side wall portions 35c of the lower wiring guide 35.

The curved wall portion 45 includes cap-side locking pieces 47 forming second locking structures 47A together with the locking protrusions 35d1 of the bridged wall portion 35d of the lower wiring guide 35.

Between the side wall portions 44 and the curved wall portion 45 are provided shoulder portions 45a each having a bent shape when viewed from the front-rear direction. A central protrusion 45b is provided between the left and right cap-side locking pieces 47 of the curved wall portion 45.

In the curved wall portion 45, the left and right shoulder portions 45a, the left and right cap-side locking pieces 47, and the central protrusion 45b are disposed side by side along the bridged wall portion 35d of the lower wiring guide 35 (so as to be curved in an arc shape as a whole) when viewed from the front-rear direction.

A front surface side of the rear wall portion 43 includes rubber stopper abutting portions (plug abutting portions) 43a, 43b that protrude forward toward the routing passages K1, K2, are inserted into the guide bodies 35a, 35b, and are capable of abutting on rear end surfaces of the rubber stoppers 37, 38, respectively.

Each of the cut-outs 41, 42 is formed so as to avoid the corresponding electric wire (the ground wiring 41a or the signal wirings 42a) when the cap member 40 is attached to the lower wiring guide 35. At this time, portions of the rear wall portion 43 along lower inner peripheries of the cut-outs 41, 42 (hereinafter, referred to as cut-out inner peripheral portions) overlap lower outer peripheral portions of the corresponding rubber stoppers 37, 38. The U-shaped rubber stopper abutting portions 43a, 43b extend forward so as to protrude forward from the cut-out inner peripheral portions in rear end view. Internal spaces extending over the cut-outs 41, 42 and the rubber stopper abutting portions 43a, 43b each extend in the up-down direction with a constant left-right width, and the corresponding wirings 41a, 42a can be easily inserted and removed in the up-down direction.

The cap member 40 has an effect of suppressing bending of each of the wirings 41a, 42a in the vicinity of each of the rubber stoppers 37, 38 so that sealability of each of the rubber stoppers 37, 38 is not affected when tension in the bending direction is applied due to the routing or the like of each of the wirings 41a, 42a.

Since the cut-outs 41, 42 through which the wirings 41a, 42a pass are U-shaped, the cap member 40 cannot suppress upward bending of the wirings 41a, 42a. However, the housing 90 is located close to above each of the wirings 41a, 42a, and the upward bending of each of the wirings 41a, 42a is suppressed by the housing 90. Therefore, the influence on the sealability of each of the rubber stoppers 37, 38 can be suppressed in all directions of each of the wirings 41a, 42a.

### Assembling Procedure of Cap Member 40

Next, an assembling procedure of the cap member 40 will be described.

The cap member 40 can be attached to the lower wiring guide 35 in a state where the wirings 41a, 42a are assembled with the housing 90 in advance. That is, when the cap member 40 is attached to the lower wiring guide 35, even in a state where the wirings 41a, 42a are already routed, the wirings 41a, 42a can be brought from open portions of the cut-outs 41, 42 of the cap member 40 to central portions in the up-down direction (portions located in an extending direction of wiring insertion portions). With this constitution, as compared with a case where each of the wiring insertion portions of the cap member 40 has a hole shape, it is not necessary to take a measure such as causing the wirings 41a, 42a to pass through the wiring insertion portions of the cap member 40 in advance, and the assembly of the cap member 40 can be facilitated.

The lower wiring guide 35 has a left-right width larger than an up-down width, and can suppress displacement of an attachment position of the cap member 40, inclination in the left-right direction, rotation around each of the wirings, and the like. In particular, since the cut-out 41 is opened upward, there is a possibility that the cap member 40 floats downward even when the wirings 41a, 42a are inserted. However, the floating of the cap member 40 can be stably suppressed by having the locking structures 46A on the left and right side wall portions 44 of the lower wiring guide 35. Even in the constitution in which each of the cut-outs 41, 42 is opened upward, the housing 90 is located close to an upper side of the cap member 40, and water from above is suppressed by the housing 90.

Both the left and right sides of the lower end portions of the lower wiring guide 35 and the cap member 40 (the bridged wall portion 35d and the curved wall portion 45) have the second locking structures 47A. That is, the second locking structures 47A are provided at portions avoiding downward tops of the lower wiring guide 35 and the cap member 40. With this constitution, downward protruding shapes (peak shapes) of the lower wiring guide 35 and the cap member 40 can be suppressed, and the housing 90 and the cap member 40 can be easily molded. The lower wiring guide 35 and the cap member 40 have the second locking structures 47A on both the left and right sides of the lower end portions, and the locking structures 46A on the left and right side wall portions 44, so that locking on both the left and right sides of the lower wiring guide 35 and the cap member 40 is strengthened, and the cap member 40 can be stably fixed.

### Operation and Effects

The charging inlet 1 of one embodiment includes: the housing 90 from which a charging plug is detachable, the housing 90 holding the connection terminals 12 therein; the plurality of wiring components (the ground wiring 41a, the signal wirings 42a) inserted into the housing 90 from an outside of the housing 90 through the lower wiring guide 35 formed on the side of the outer surfaces 31a, 32b of the outer wall portions (the terminal holding portions 31, the coupling portion 32) of the housing 90; the plurality of waterproof plugs (the rubber stoppers 37, 38) inserted into the plurality of routing passages K1, K2 formed inside the lower wiring guide 35 together with the corresponding wiring components to close the routing passages K1, K2; and the cap member 40 that is attached to the external opening portion 36 of the lower wiring guide 35, the external opening portion 36 being opened to the outside of the housing 90, and that has the plurality of abutting portions 43a, 43b capable of abutting on the waterproof plugs 37, 38 inside the routing passages K1, K2 from a side of the external opening portion 36.

According to this constitution, in the charging inlet 1 in which the plurality of wiring components such as the ground wiring 41a and the signal wirings 42a are disposed from the lower wiring guide 35 into the housing 90, the plurality of routing passages K1, K2 inside the lower wiring guide 35 are watertightly closed by the waterproof plugs 37, 38 through which the wirings 41a, 42a are inserted, and the sealability inside the housing 90 is secured. The external opening portion 36 of the lower wiring guide 35 is closed by the cap member 40, and the abutting portions 43a, 43b of the cap member 40 press the waterproof plugs 37, 38 inside the routing passage K1 to suppress the falling-off of the waterproof plugs 37, 38. Even if bending (deflection) of the wiring components occurs, forces due to the bending are received by the corresponding cut-outs 41, 42 before the waterproof plugs 37, 38, so that the forces due to the bending of the wiring components are hardly applied to the waterproof plugs 37, 38, and a waterproof property is satisfactorily secured. Since the plurality of rubber stoppers 37, 38 are held by the one cap member 40, assembling workability of the charging inlet 1 can be improved.

In the charging inlet 1 of the one embodiment, the cap member 40 includes the plurality of U-shaped cut-outs 41, 42 that open toward the side of the outer wall portions 31, 32 in the second direction (the up-down direction Z) intersecting the outer surfaces 31a, 32b of the outer wall portions 31, 32 (particularly, orthogonal to the lower surface 32b of the coupling portion 32) when viewed from the first direction (the front-rear direction Y) along the outer surfaces 31a, 32b of the outer wall portions 31, 32, and the corresponding wiring components are inserted into the cut-outs 41, 42.

According to this constitution, since the insertion portions of the wiring components in the cap member 40 are the U-shaped cut-outs opened to the side of the outer wall portion of the housing 90, the cap member 40 can be attached to the lower wiring guide 35 while inserting the wirings 41a, 42a into the cut-outs 41, 42 in a state where the wiring components are assembled with the lower wiring guide 35. With this constitution, the cap member 40 can be assembled without passing the electric wires in advance, and there is no work of sandwiching the electric wires with the cap member 40, and the assembling workability of the charging inlet 1 can be improved.

In the charging inlet 1 of the one embodiment, the housing 90 includes the base holder 50 that extends in the first direction (the front-rear direction Y) and accommodates the pair of connection terminals 12 for charging, the base holder 50 includes: the pair of holder bodies (the terminal holding portions) 31 that each have a tubular shape extending in the first direction and holds each of the connection terminals 12; and the holder enlarged portion (the inner housing body) 60 to which one-end portions of the terminal holding portions 31 in the first direction are connected and that has an enlarged shape overlapping with the terminal holding portions 31 when viewed from the first direction, and the lower wiring guide 35 extends in the third direction (the left-right direction X) intersecting the second direction (the up-down direction Z) when viewed from the first direction, is disposed across outer peripheral portions of the pair of holder bodies 31, and is formed to have a width in the third direction wider than a width in the second direction.

According to this constitution, since the lower wiring guide 35 is provided so as to be wider in the third direction than in the second direction along with the parallel arrangement of the terminal holding portions 31, the cap member 40 attached to the external opening portion 36 of the lower wiring guide 35 is restrained from moving in a rotating direction when viewed from the first direction. With this constitution, stable attachment of the cap member 40 can be realized.

In the charging inlet 1 of the one embodiment, the lower wiring guide 35 includes: the guide outer wall portion (the bridged wall portion) 35d extending in the third direction at a position spaced apart from the housing 90 in the second direction when viewed from the first direction, and curved along the outer shape of the holder enlarged portion 60; and the pair of side wall portions 44 extending from end portions of the guide outer wall portion 35d in the third direction toward a side of the terminal holding portions 31 in the second direction, and the pair of side wall portions 44 includes the locking structures 46A that lock the cap member 40 and restrict detachment of the cap member 40 in the first direction.

According to this constitution, the locking structures 46A for locking the cap member 40 are provided on the side wall portions 44 on both sides in the third direction of the lower wiring guide 35, so that the cap member 40 elongated in the third direction can be stably attached. In addition, it is possible to prevent the cap member 40 from floating on a side opposite to the opening portions of the cut-outs 41, 42 and to suppress rotation of the cap member 40 around the wirings.

In the charging inlet 1 of the one embodiment, the bridged wall portion 35d of the lower wiring guide 35 has an arc shape along the outer shape of the holder enlarged portion 60 when viewed from the first direction, and the charging inlet 1 includes the pair of second locking structures 47A on both sides (portions closer to the side wall portions 35c than the central portion) avoiding the central portion in the third direction in the bridged wall portion 35d.

According to this constitution, by providing the pair of second locking structures 47A on both the sides of the guide outer wall portion 35d, the pair of second locking structures 47A of the guide outer wall portion 35d can be disposed close to the locking structures 46A of the left and right side wall portions 35c, respectively, and the cap member 40 can be firmly attached.

In the above embodiment, an example in which the present invention is applied to the lower wiring guide 35 provided in the upper portion of the housing 90 has been described, but the present invention is not limited to this constitution. For example, the present invention may be applied to a wiring guide provided on an upper portion or a side portion of the housing 90.

The constitution in the above embodiment is one example of the present invention, and various modifications can be made without departing from the gist of the present invention, such as replacing the components of the embodiment with known components.

### DESCRIPTION OF REFERENCE SYMBOLS

1 charging inlet
12 connection terminal
31 terminal holding portion (holder body, outer wall portion)
32 coupling portion (coupling portion)
31a, 32b, 32C outer surface
35 lower wiring guide (wiring guide)
35c side wall portion
35d bridged wall portion (guide outer wall portion)
36 external opening portion
37, 38 rubber stopper (waterproof plug)
40 cap member
41a ground wiring (wiring)
42a signal wiring (wiring)
43a, 43b rubber stopper abutting portion (plug abutting portion)
44 side wall portion
46A locking structure
47A second locking structure
50 base holder
60 inner housing body (holder enlarged portion)
90 housing
K1, K2 routing passage
X left-right direction
Y front-rear direction
Z up-down direction

1. A charging inlet comprising:
a housing from which a charging plug is detachable, the housing holding connection terminals therein;
a plurality of wiring components inserted into the housing from an outside of the housing through a wiring guide formed on a side of outer surfaces of outer wall portions of the housing;
a plurality of waterproof plugs inserted into a plurality of routing passages formed inside the wiring guide together with the corresponding wiring components to close the routing passages; and
a cap member that is attached to an external opening portion of the wiring guide, the external opening portion being opened to the outside of the housing, and that has a plurality of abutting portions capable of abutting on the waterproof plugs inside the routing passages from a side of the external opening portion.

2. The charging inlet according to claim 1, wherein
the cap member includes a plurality of U-shaped cut-outs that open toward a side of the outer wall portions in a second direction intersecting the outer surfaces of the outer wall portions when viewed from a first direction along the outer surfaces of the outer wall portions, and the corresponding wiring components are inserted into the cut-outs.

3. The charging inlet according to claim 2, wherein
the housing includes a base holder that extends in the first direction and accommodates the pair of connection terminals for charging,
the base holder includes:
a pair of holder bodies that each have a tubular shape extending in the first direction and hold each of the connection terminals; and
a holder enlarged portion to which one-end portions of the holder bodies in the first direction are connected and that has an enlarged shape overlapping with the holder bodies when viewed from the first direction, and
the wiring guide extends in a third direction intersecting the second direction when viewed from the first direction, is disposed across outer peripheral portions of the pair of holder bodies, and is formed to have a width in the third direction wider than a width in the second direction.

4. The charging inlet according to claim 3, wherein
the wiring guide includes:
a guide outer wall portion extending in the third direction at a position spaced apart from the housing in the second direction when viewed from the first direction; and
a pair of side wall portions extending from end portions of the guide outer wall portion in the third direction toward a side of the holder bodies in the second direction, and
the pair of side wall portions includes locking structures that lock the cap member and restrict detachment of the cap member in the first direction.

5. The charging inlet according to claim 4, further comprising a pair of second locking structures that locks the cap member and restricts detachment of the cap member in the first direction on both sides of the guide outer wall portion avoiding a central portion in the third direction.
